(19) United States
(12) Patent Application Publication
(10) Pub. No.: US 2012/0127166 A1
(43) Pub. Date: May 24, 2012

(54) DISPLAY DEVICE, METHOD OF CONTROLLING DISPLAY DEVICE, AND PROGRAM

(75) Inventor: Naoki Suzuki, Matsumoto-shi (JP)

(73) Assignee: Seiko Epson Corporation, Tokyo (JP)

(21) Appl. No.: 13/298,449

(22) Filed: Nov. 17, 2011

(30) Foreign Application Priority Data
Nov. 18, 2010 (JP) 2010-257572

(51) Int. Cl. G06T 15/00

(52) U.S. Cl. 345/419

(57) ABSTRACT

A display device includes: an image acquisition unit that acquires a left-eye image and a right-eye image based on an input image; a storage unit that stores an OSD image; an OSD image acquisition unit that acquires at least one of a left-eye OSD image and a right-eye OSD image based on the OSD image stored in the storage unit; an image combination unit that superimposes the OSD images acquired by the OSD image acquisition unit on the left and right-eye images acquired by the image acquisition unit to thereby generate an image; and a display unit that displays the image generated by the image combination unit.

The entire disclosure of Japanese Patent Application No. 2010-257572, filed Nov. 18, 2010 is expressly incorporated by reference herein.

### BACKGROUND

1. Technical Field

The present invention relates to a display device that displays images, a method of controlling the display device, and a program.

2. Related Art

In recent years, a so-called OSD display function has been known, in which a display device displaying an input image displays a menu screen or the like to be superimposed on the image being displayed. JP-A-2008-216460 discloses a device capable of displaying an OSD image of various colors by combining the colors of the OSD image in units of pixels.

Moreover, in recent years, display devices that display 3D (stereo) images have been known. Display devices of this kind display stereoscopic images by showing different images to the right and left eyes of a viewer by using a configuration (for example, see JP-A-7-284128) which uses polarized glasses or a configuration (for example, see JP-A-5-304685) in which lenticular lenses are disposed on a display surface.

However, when applying a 3D image display method to the display of OSD images, how the display was to be realized was a problem which was not solved. In the related art, when displaying OSD images, it is a common practice to superimpose an OSD image stored in advance on an input image similarly to the display device described above. However, unlike a planar (2D) image, a 3D image is composed of pairs of right and left-eye images, and a technique on how to superimpose the OSD image on each of the right and left-eye images is not known. In addition, a technique which uses a 3D image as the OSD image itself is not known.

### SUMMARY

An advantage of some aspects of the invention is to solve at least part of the problems described above and the invention can be implemented as the following forms or aspects.

An aspect of the invention is directed to a display device including: an image acquisition unit that acquires a left-eye image and a right-eye image based on an input image; a storage unit that stores an OSD image; an OSD image acquisition unit that acquires at least one of a left-eye OSD image and a right-eye OSD image based on the OSD image stored in the storage unit; an image combination unit that superimposes the OSD images acquired by the OSD image acquisition unit on the left and right-eye images acquired by the image acquisition unit to thereby generate an image; and a display unit that displays the image generated by the image combination unit.

According to the above aspect of the invention, it is possible to display the OSD image so as to be superimposed on an image including the left and right-eye images. In this case, when the same image is used as the left and right-eye OSD images, only the OSD image can be displayed as a 2D image. When a pair of images with parallax is used as the left and right-eye OSD images, the OSD image can be displayed in 3D. In this way, it is possible to display the OSD image effectively by combining the 3D image and the OSD image.

According to the above aspect of the invention, it is possible to display the left and right-eye OSD images so as to be superimposed on the input 3D image appropriately so as to correspond to the image format of the input 3D image.

According to the above aspect of the invention, it is possible to reliably discriminate the left and right-eye images input alternately and to display the left and right-eye OSD images so as to be superimposed on the input 3D image appropriately.

According to the above aspect of the invention, when the input image is a 2D image, it is possible to generate the left and right-eye images based on the 2D image and to display the left and right-eye OSD images so as to be superimposed on the respective images. Thus, even when the input image is a 2D image, it is possible to display the OSD image in 3D and to effectively display the OSD image.

According to the above aspect of the invention, since the left and right-eye OSD images which are stored in advance are read and superimposed, it is possible to quickly execute the process of superimposing the OSD image.

According to the above aspect of the invention, it is possible to display a 2D OSD image by using the left and right-eye OSD images which are stored in advance in order to display the OSD image in 3D.

According to the above aspect of the invention, it is possible to display the OSD image in 3D with a small storage capacity.

By executing the control method according to another aspect of the invention, it is possible to display the OSD image so as to be superimposed on an image including the left and right-eye images. In this case, when the same image is used as the left and right-eye OSD images, only the OSD image can be displayed as a 2D image. When a pair of images with parallax is used as the left and right-eye OSD images, the OSD image can be displayed in 3D. In this way, it is possible to display the OSD image effectively by combining the 3D image and the OSD image.

By allowing a computer to execute the program according to still another aspect of the invention, it is possible to display the OSD image so as to be superimposed on an image including the left and right-eye images. In this case, when the same image is used as the left and right-eye OSD images, only the OSD image can be displayed as a 2D image. When a pair of images with parallax is used as the left and right-eye OSD images, the OSD image can be displayed in 3D. In this way, it is possible to display the OSD image effectively by combining the 3D image and the OSD image.

According to the above aspects of the invention, it is possible to superimpose the OSD image on an image including the left and right-eye images to display the OSD image as a 2D image or a 3D image. Moreover, it is possible to effectively display an OSD image by combining a 3D image and an OSD image.

### BRIEF DESCRIPTION OF THE DRAWINGS

The invention will be described with reference to the accompanying drawings, wherein like numbers reference like elements.

FIG. 1 is a block diagram showing a configuration of a projector according to an embodiment of the invention.

FIG. 2 is a diagram illustrating a configuration example of an OSD image memory.

FIGS. 3A and 3B are schematic diagrams showing an example of a process of superimposing an OSD image on an input video image, in which FIG. 3A shows an OSD image generated by an image combiner, and FIG. 3B shows an image in which an OSD image is superimposed on an input video image.

FIGS. 4A and 4B are schematic diagrams showing another example of a process of superimposing an OSD image on an input video image, in which FIG. 4A shows an OSD image to be superimposed, and FIG. 4B shows an image in which an OSD image is superimposed on an input video image.

FIGS. 5A and 5B are schematic diagrams showing still another example of a process of superimposing an OSD image on an input video image, in which FIG. 5A shows an OSD image to be superimposed, and FIG. 5B shows an image in which an OSD image is superimposed on an input video image.

FIGS. 6A to 6C are diagrams showing a detailed configuration example of an OSD image stored in an OSD image memory, in which FIG. 6A shows a left-eye OSD image, FIG. 6B shows a right-eye OSD image, and FIG. 6C shows an example of an OSD image viewed when these images are projected.

FIGS. 7A to 7F are diagrams showing a display example in which an OSD image is displayed so as to be superimposed on an input video image, in which FIG. 7A shows an example in which a 2D OSD image is displayed so as to be superimposed on a 2D image, FIG. 7B shows an example in which the display of FIG. 7A is corrected, FIG. 7C shows an example in which a 3D OSD image is displayed so as to be superimposed on a 2D image, FIG. 7D shows an example in which a 2D OSD image is displayed so as to be superimposed on a 3D image, FIG. 7E shows an example in which the display of FIG. 7D is corrected, and FIG. 7F shows an example in which a 3D OSD image is displayed so as to be superimposed on a 3D image.

FIG. 8 is a flowchart showing the operation of the projector.

### DESCRIPTION OF EXEMPLARY EMBODIMENTS

Hereinafter, embodiments of the invention will be described with reference to the drawings.

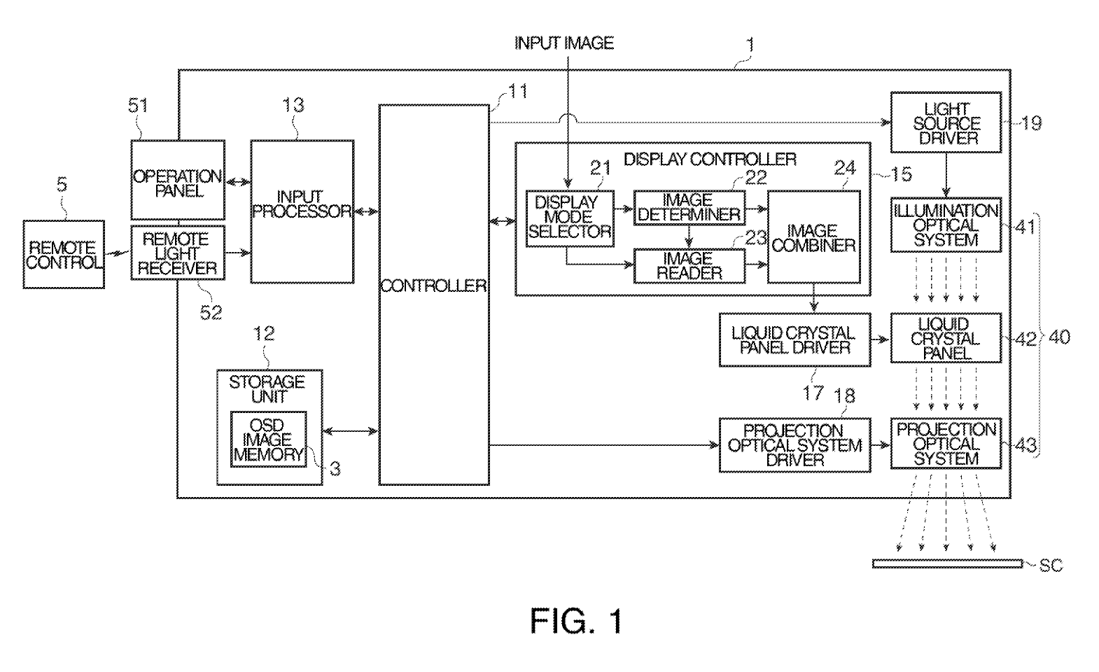

FIG. 1 is a block diagram showing an overall configuration of a projector 1 as a display device to which the invention is applied. The projector 1 is a device which is connected to an external image supply device (not shown) of a personal computer, various video players, and the like, and which projects an input image input from the image supply device onto a screen SC. Examples of the image supply device include a video output device such as a video player, a DVD player, a TV tuner, a CATV set-top box, or a video game console, a personal computer, and the like. In the present embodiment, it is assumed that digital video data is input from the image supply device to a display controller 15. The digital video data includes information on the image format (including the format and the frame rate of 3D video) of the digital video data as well as the video data itself.

The projector 1 is capable of displaying both still images and moving images (video images). In the following description, a case of displaying and outputting moving images input from the image supply device will be described as an example. That is, in the following description, the process of displaying an input image can be equally applied to a case of displaying still images.

In the present embodiment, the screen SC is approximately vertical, and the screen surface has a rectangular shape. The images input to the projector 1 may be both moving images (video images) and still images, and the projector 1 is capable of projecting a video onto the screen SC and continuously projecting still images onto the screen SC.

The projector 1 mainly includes a display unit 40 (display unit) that forms an optical image and an image processing system that electrically processes the video signal input to the display unit 40. The display unit 40 includes an illumination optical system 41, a liquid crystal panel 42, and a projection optical system 43. The illumination optical system 41 includes a light source which is formed of a xenon lamp, an ultrahigh-pressure mercury lamp, an LED, or the like. Moreover, the illumination optical system 41 may include a reflecting mirror and an auxiliary reflecting mirror that guide light emitted from the light source to a liquid crystal panel 42. Furthermore, the illumination optical system 41 may include a lens array (not shown) and a polarizing plate for enhancing the optical properties of projection light or may include a dimmer that attenuates the intensity of light emitted from the light source on an optical path along which the light arrives at the liquid crystal panel 42.

The liquid crystal panel 42 receives signals from the image processing system described later and forms images on the panel surface. The liquid crystal panel 42 is composed of three liquid crystal panels corresponding to the three primary colors of RGB in order to realize color projection. Thus, the light from the illumination optical system 41 is separated into color light components of the three colors RGB, and the respective color light components enter the respective liquid crystal panels. The color light components modulated after passing through the respective liquid crystal panels are combined by a combination optical system such as a cross dichroic prism and output to the projection optical system 43.

The projection optical system 43 includes a zoom lens that adjusts the zooming and focusing of an image to be projected, a motor for adjusting the degree of zooming, and a motor for adjusting the focusing. The projection optical system 43 projects and images an incident light modulated by the liquid crystal panel 42 onto the screen SC using the zoom lens.

The display unit 40 is connected to a projection optical system driver 18 that drives the respective motors of the projection optical system 43 in accordance with the control of the controller 11 and a light source driver 19 that drives the light source of the illumination optical system 41 in accordance with the control of the controller 11.

The image processing system is mainly composed of the controller 11 that controls the overall operation of the projector 1 in an integrated manner, and includes a storage unit 12 that stores data processed by the controller 11 and programs executed by the controller 11, an input processor 13 that detects operations input through an operation panel 51 and a remote light receiver 52, a display controller 15 that processes an input video image, and a liquid crystal panel driver 17 that drives the liquid crystal panel 42 based on the video signal output from the display controller 15 to thereby perform drawing.

The controller 11 controls the respective constituent elements of the projector 1 by reading and executing a control program stored in the storage unit 12. The controller 11 detects the content of an operation performed by a user based on an operation signal input from the input processor 13 and controls the display controller 15, the liquid crystal panel driver 17, the projection optical system driver 18, and the light source driver 19 to thereby project a video image onto the screen SC.

Moreover, the storage unit 12 includes an OSD image memory 3 (storage unit) for storing image data of an OSD image in addition to a storage area for storing the control program and data described above.

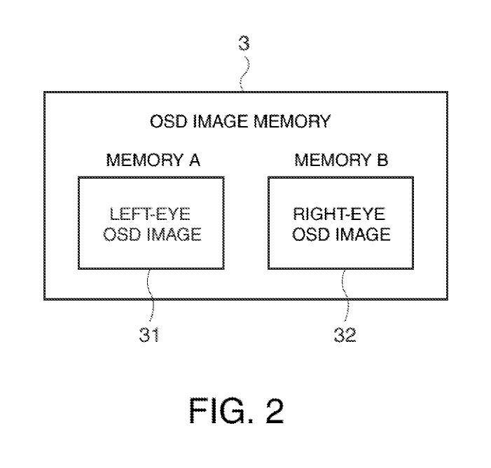

FIG. 2 is a diagram illustrating a configuration example of the OSD image memory 3. As shown in FIG. 2, a left-eye OSD image 31 and a right-eye OSD image 32 for displaying an OSD image in 3D are stored in the OSD image memory 3. Memories A and B are included in the OSD image memory 3, and the left-eye OSD image 31 and the right-eye OSD image 32 are expanded and stored in the memories A and B, respectively.

The operation panel 51 includes various switches for allowing the user to perform operations and an indicator lamp is arranged on the main body of the projector 1. The operation panel 51 is connected to the input processor 13, and the input processor 13 causes the indicator lamp of the operation panel 51 to be appropriately switched on and off based on the operation state or setting state of the projector 1 in accordance with the control of the controller 11. When a switch of the operation panel 51 is operated, an operation signal corresponding to the operated switch is output from the input processor 13 to the controller 11.

Moreover, the projector 1 includes a remote control 5 used by the user. The remote control 5 includes various buttons and transmits an infrared light signal in correspondence to the operations of these buttons. The remote light receiver 52 for receiving the infrared light signal emitted by the remote control 5 is arranged on the main body of the projector 1. The remote light receiver 52 decodes the infrared light signal received from the remote control 5, generates an operation signal indicating the content of the operation in the remote control 5, and outputs the operation signal to the controller 11.

The display controller 15 is connected to the external image supply device (not shown). The display controller 15 generates a display signal based on the input video image signal input from the image supply device in accordance with the control of the controller 11 and outputs the display signal to the liquid crystal panel driver 17.

Moreover, the display controller 15 includes a display mode selector 21 that selects a display mode of the OSD image in accordance with the control of the controller 11, an image determiner 22 (determining unit) that performs determination on the input video image, an image reader 23 (OSD image acquisition unit) that reads the OSD image from the OSD image memory 3 in accordance with the result of the determination by the image determiner 22, and an image combiner 24 (an image acquisition unit and an image combination unit) that combines the OSD image and the input video image by superimposition to thereby generate a display video image.

The display mode selector 21 selects whether the OSD image will be displayed as a 2D image or a 3D image in accordance with the control of the controller 11. Whether the OSD image will be displayed in 2D or 3D is determined based on the operation of the input processor 13, the preconfiguration or the like.

The image determiner 22 determines whether the input video image is a 3D video image or a 2D video image, and determines the video format of the input video image when the input video image is a 3D video image. Examples of the format of the 3D video image include a line alternative format, a frame sequential format, a side-by-side format, and the like. When the input video image is a 3D video image, the image determiner 22 determines whether the respective frames or lines of the 3D video image are right-eye images or left-eye images.

When the display mode selector 21 has selected 3D display as the display mode of the OSD image, the image reader 23 reads the left-eye OSD image 31 and the right-eye OSD image 32 from the OSD image memory 3 and outputs the images to the image combiner 24. Moreover, when the display mode selector 21 has selected 2D display as the display mode of the OSD image, the image reader 23 reads only the left-eye OSD image 31 from the OSD image memory 3 and outputs the image to the image combiner 24.

The image combiner 24 performs a process of superimposing the OSD image input from the image reader 23 on the input video image. Here, when the image determiner 22 has determined that the input video image is a 3D video image, the image combiner 24 superimposes the OSD image on the input video image so as to match the video format of the 3D video image determined by the image determiner 22.

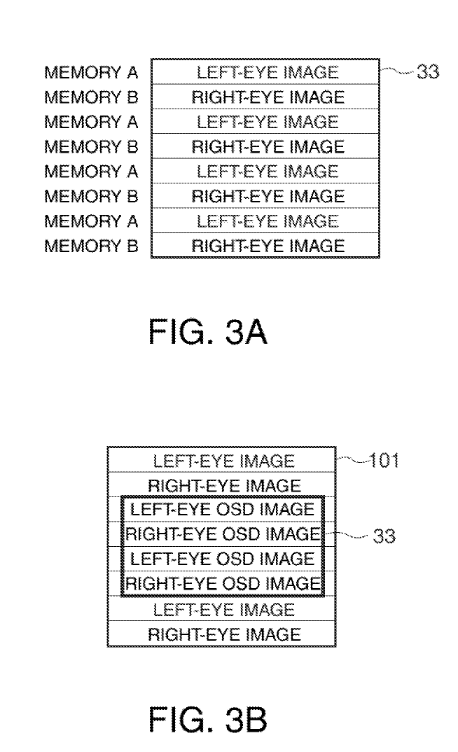

FIGS. 3A and 3B are schematic diagrams showing an example of a process by the image combiner 24 of superimposing an OSD image on an input video image, and specifically, show an example of processing an input video image of the line alternative format. FIG. 3A shows an OSD image generated by the image combiner 24, and FIG. 3B shows an image in which an OSD image is superimposed on an input video image.

A 3D video image of the line alternative format is an image in which a right-eye image and a left-eye image are alternately arranged in units of horizontal lines. In order to correspond to this image, the image reader 23 reads and outputs one line of left-eye OSD images 31 from the memory A of the OSD image memory 3 to the image combiner 24, and subsequently, reads and outputs one line of right-eye OSD images 32 from the memory B of the OSD image memory 3 to the image combiner 24. By repeatedly performing this operation, the image reader 23 alternately outputs the left-eye OSD image 31 and the right-eye OSD image 32. The image combiner 24 combines the left and right-eye OSD images 31 and 32 alternately input in units of lines from the image reader 23 to generate an OSD image 33 shown in FIG. 3A and superimposes this OSD image on the input video image of the line alternative format to generate a display image 101 shown in FIG. 3B. The display image 101 is an image in which the OSD image 33 is superimposed on the center of the 3D video image of the line alternative format, in which right and left-eye frames are alternately arranged in units of lines. The right-eye OSD image 32 of the OSD image 33 overlaps with the lines of right-eye frames of the display image 101, and the left-eye OSD image 31 overlaps with the lines of left-eye frames. Here, since the image combiner 24 discriminates whether the respective lines are left-eye frames or right-eye frames based on the determination result input from the image determiner 22, there is no possibility of the left and right-eye frames being processed in a reversed manner.

Moreover, the vertical resolution of the input video image of the line alternative format is compressed to half so that a pair of left and right-eye frames is combined so as to have a size corresponding to one frame. Thus, the image combiner 24 performs a process of inserting horizontal lines to increase the vertical resolution in order to break down the input video image into left-eye frames and right-eye frames. The image combiner 24 may superimpose the OSD image 33 after performing the process of interpolating horizontal lines of the input video image and may perform the process of interpolating the horizontal lines of the display image 101 in which the OSD image 33 is superimposed. It is desirable to superimpose the OSD image 33 after performing the process of interpolating the horizontal lines of the input video image because it is not necessary to convert the resolution of the left and right-eye OSD images 31 and 32, and the amount of computation can be suppressed.

The image combiner 24 draws and expands the right and left-eye frames in an internal frame memory (not shown) based on the display image 101 and outputs the right and left-eye frames alternately to the liquid crystal panel driver 17. In this way, the right and left-eye frames are alternately projected onto the screen SC in a switching manner. Thus, a person wearing polarized glasses, for example, can see an OSD image superimposed on the input video image.

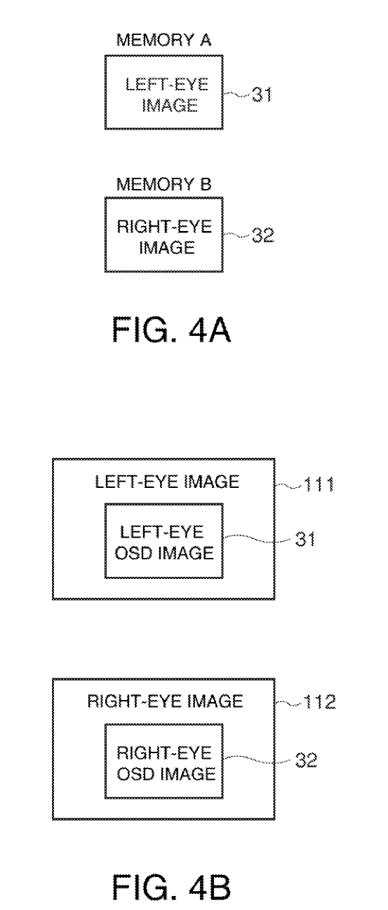

FIGS. 4A and 4B are schematic diagrams showing an example of a process by the image combiner 24 of superimposing an OSD image on an input video image, and specifically, show an example of processing an input video image of the frame sequential format. FIG. 4A shows an OSD image to be superimposed, and FIG. 4B shows an image in which an OSD image is superimposed.

A 3D video image of the frame sequential format is an image in which a right-eye frame and a left-eye frame are alternately input in units of frames. Thus, the image reader 23 reads left-eye OSD images 31 from the memory A of the OSD image memory 3, reads right-eye OSD images 32 from the memory B, and outputs these left and right-eye OSD images 31 and 32 alternately to the image combiner 24.

As shown in FIG. 4B, the image combiner 24 superimposes the left-eye OSD image 31 on the left-eye frame of the input video image input from the image determiner 22 to generate a left-eye display image 111, and superimposes the right-eye OSD image 32 to the right-eye frame to thereby generate a right-eye display image 112. Here, since the image combiner 24 discriminates whether the respective frames are left-eye frames or right-eye frames based on the determination result input from the image determiner 22, there is no possibility of the left and right-eye images being processed in a reversed manner.

The image combiner 24 draws and expands the left and right-eye display images 111 and 112 in an internal frame memory (not shown) and outputs the right and left-eye display images alternately to the liquid crystal panel driver 17. In this way, the right and left-eye frames are alternately projected onto the screen SC in a switching manner. Thus, a person wearing polarized glasses, for example, can see an OSD image superimposed on the input video image.

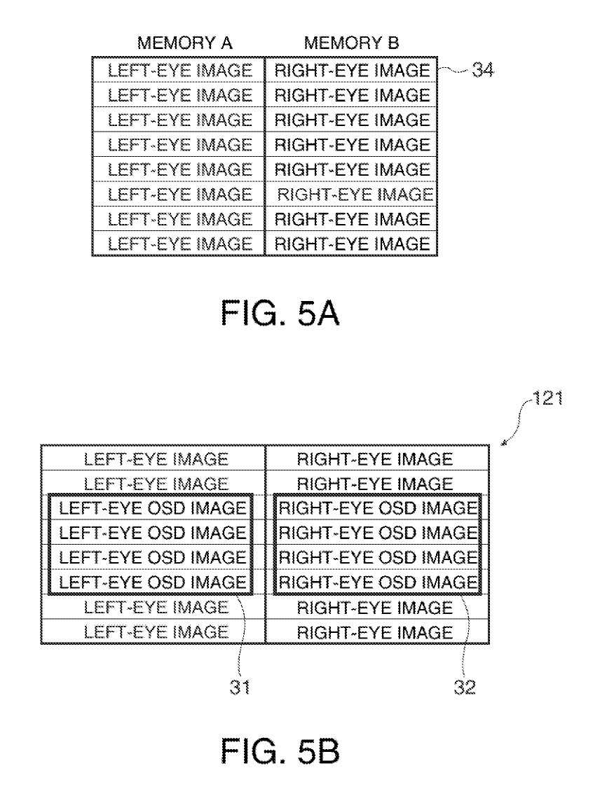

FIGS. 5A and 5B are schematic diagrams showing an example of a process by the image combiner 24 of superimposing an OSD image on an input video image, and specifically, show an example of processing an input video image of the side-by-side format. FIG. 5A shows an OSD image to be superimposed, and FIG. 5B shows an image in which an OSD image is superimposed.

A 3D video image of the side-by-side format is an image in which right and left-eye frames are arranged in the lateral direction and compressed so as to have a size corresponding to one frame. Thus, the image reader 23 reads left-eye OSD images 31 from the memory A of the OSD image memory 3, reads right-eye OSD images 32 from the memory B, generates an OSD image 34 in which these left and right-eye OSD images 31 and 32 are arranged in the horizontal direction, and outputs the OSD image 34 to the image combiner 24.

Moreover, the horizontal resolution of the input video image of the side-by-side half format is compressed to half so that a pair of left and right-eye frames is combined so as to have a size corresponding to one frame. Thus, the image combiner 24 performs a process of inserting pixels of the respective lines to increase the horizontal resolution in order to break down the input video image into left-eye frames and right-eye frames. The image combiner 24 may superimpose the OSD image 34 to generate the display image 121 after performing the process of interpolating pixels and may perform the process of interpolating pixels of the display image 121 in which the OSD image 34 is superimposed. It is desirable to superimpose the OSD image 34 to generate the display image 121 after performing the process of interpolating pixels because it is not necessary to convert the resolution of the left and right-eye OSD images 31 and 32, and the amount of computation can be suppressed.

As shown in FIG. 5B, the image combiner 24 superimposes the left and right-eye OSD images 31 and 32 on the input video image input from the image determiner 22 in regions where the left and right-eye frames are positioned, respectively. Here, since the image combiner 24 discriminates the regions of the left and right-eye frames based on the determination result input from the image determiner 22, there is no possibility of the left and right-eye images being processed in a reversed manner.

The image combiner 24 draws and expands the right and left-eye frames in which the OSD image is superimposed in an internal frame memory (not shown) based on the display image 121 and outputs the right and left-eye frames alternately to the liquid crystal panel driver 17. In this way, the right and left-eye frames are alternately projected onto the screen SC in a switching manner. Thus, a person wearing polarized glasses, for example, can see an OSD image superimposed on the input video image.

As such, when the input video image is a 3D video image, the projector 1 superimposes the left and right-eye OSD images 31 and 32 on the left and right-eye frames of the 3D video image, respectively, and projects the left and right-eye frames onto the screen SC. In this way, it is possible to display the OSD image on the 3D video image.

Here, the left and right-eye OSD images 31 and 32 and the OSD images 33 and 34 generated based on these images have an opaque background. Although it is also possible to display the OSD image semi-transparently so that the image on the background of the OSD image can be seen through, if the background of the OSD image is seen through, the images on the background of the OSD image may appear to be shifted in the left and right frames due to the difference in the parallaxes of the background image and the OSD image. As a result, there is a possibility of causing an unnatural effect on the visibility of the 3D video image. Thus, in the present embodiment, an opaque OSD image is projected onto the screen SC in a superimposed manner so that both the background 3D image and the OSD image can be visible satisfactorily.

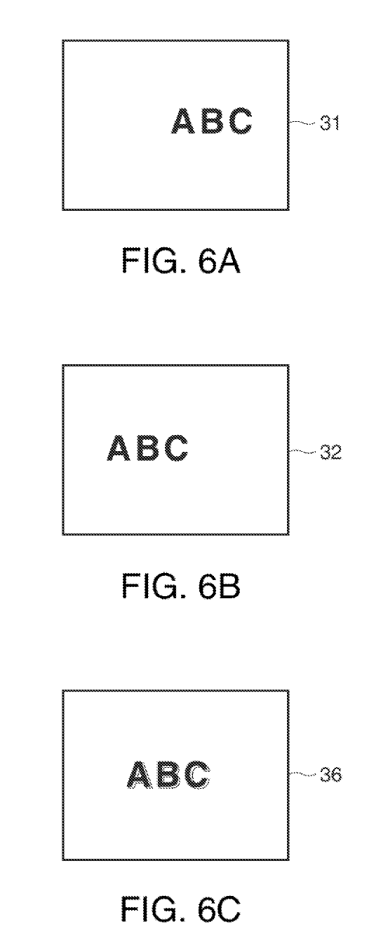

FIGS. 6A to 6C are diagrams showing a detailed configuration example of an OSD image stored in the OSD image memory 3, in which FIG. 6A shows the left-eye OSD image 31, FIG. 6B shows the right-eye OSD image 32, and FIG. 6C shows a 3D image viewed when these images are projected onto the screen SC.

The left-eye OSD image 31 illustrated in FIGS. 6A to 6C, characters which constitute a menu screen or the like are arranged on a colorless background. These characters are arranged so as to have a parallax so that they appear stereoscopically when projected on the screen SC. Thus, the characters in the left-eye OSD image 31 shown in FIG. 6A are shifted to the right side, and the characters in the right-eye OSD image 32 shown in FIG. 6B are shifted to the left side. When the left and right-eye OSD images 31 and 32 are alternately projected on the screen SC and viewed through polarized glasses, the characters will appear stereoscopically approximately at the center as shown in FIG. 6C.

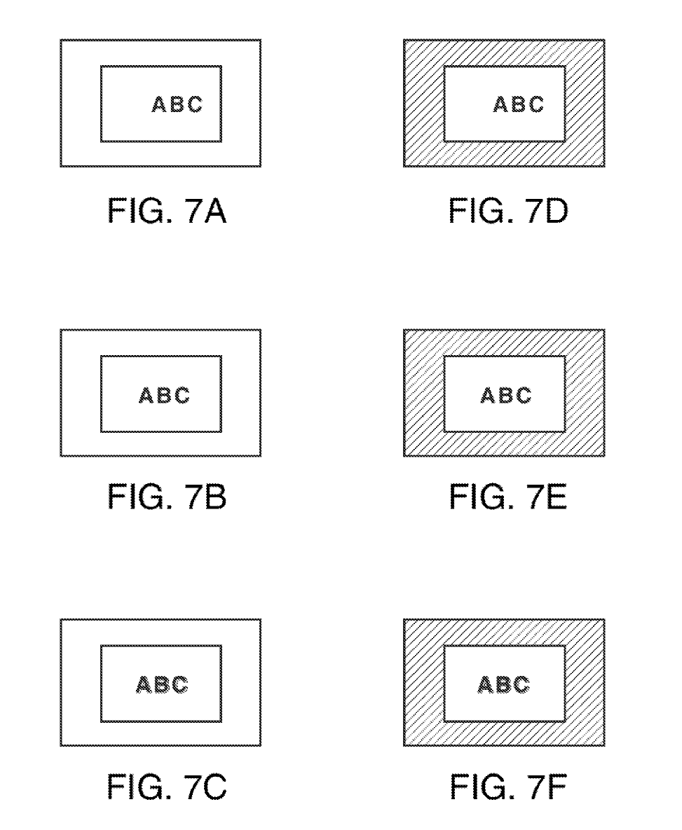

Moreover, the projector 1 of the present embodiment displays only the left-eye OSD image 31 so as to be superimposed on the input video image when the user instructs to display a 2D OSD image by operating the remote control 5 or the operation panel 51. A display pattern of this case will be described with reference to FIGS. 7A to 7F.

FIGS. 7A to 7F are diagrams showing a display example in which an OSD image is displayed so as to be superimposed on an input video image, in which FIG. 7A shows an example in which a 2D OSD image is displayed so as to be superimposed on a 2D image, FIG. 7B shows an example in which the display of FIG. 7A is corrected, FIG. 7C shows an example in which a 3D OSD image is displayed so as to be superimposed on a 2D image, FIG. 7D shows an example in which a 2D OSD image is displayed so as to be superimposed on a 3D image, FIG. 7E shows an example in which the display of FIG. 7D is corrected, and FIG. 7F shows an example in which a 3D OSD image is displayed so as to be superimposed on a 3D image. The hatched portion in FIGS. 7D to 7F indicates a portion in which the input video image is displayed in 3D.

FIG. 7A shows an example in which a 2D OSD image is superimposed on a 2D input video image and projected onto the screen SC. The projector 1 is capable of superimposing an OSD image on a 2D video image and projecting the same onto the screen SC when the input video image is a 2D video image, namely a normal video image as well as when the input video image is a 3D video image. Since the image combiner 24 needs to perform a process of acquiring the left and right-eye frames of the input image and superimposing the OSD image on the respective frames, both the left and right-eye frames of the input image are necessary. In this case, the image combiner 24 obtains the left and right-eye frames of the input image by duplicating the frames of the input image and using one of the frames as the left-eye frame and the other frame as the right-eye frame. In this case, although the image projected onto the screen SC is a 2D image, the image combiner 24 can perform the process of superimposing the OSD image similarly to the 3D video image. Moreover, when projecting a 2D OSD image onto the screen SC, the image reader 23 reads the left-eye OSD image 31, and the image combiner 24 superimposes the left-eye OSD image 31 on both the left and right-eye frames. In this way, although the OSD image projected on the screen SC is a 2D image, the image combiner 24 can perform the process of superimposing the OSD image similarly to the case of projecting an OSD image stereoscopically.

In the example of FIG. 7A, since the left-eye OSD image 31 is projected onto the screen SC as it was, the characters in the OSD image are projected at a position shifted to the left side rather than the center. Here, if it is possible to move only the characters in the left-eye OSD image 31, the characters can be corrected so as to be displayed at the center as shown in FIG. 7B. For example, the correction shown in FIG. 7B can be realized when the data of the left-eye OSD image 31 stored in the OSD image memory 3 includes information that designates an opaque background, the characters displayed on the background, and the display position of the characters.

In the example of FIG. 7C, an OSD image is displayed stereoscopically on a 2D input image. In such a case, by displaying only the OSD image in 3D during projection of the 2D image, the OSD image is highlighted more. Moreover, the display shown in FIG. 7C can be used for testing polarized glasses, for example.

FIG. 7D shows an example in which a 2D OSD image is superimposed on a 3D input video image and projected onto the screen SC. In this case, similarly to the description of FIG. 7A, the image reader 23 reads only the left-eye OSD image 31 from the OSD image memory 3 and outputs the image to the image combiner 24, and the image combiner 24 superimposes the left-eye OSD image 31 on both the left and right-eye frames.

The use of such a display pattern enables a viewer to easily see the characters in the OSD image without wearing polarized glasses. Thus, this display pattern is particularly useful when operating the remote control 5 without wearing polarized glasses. Naturally, a person wearing polarized glasses can also see the OSD image satisfactorily. The display pattern shown in FIG. 7D is useful when configuring the settings relating to the operation of the projector 1 during projection of a 3D video image.

In the screen shown in FIG. 7D, since the left-eye OSD image 31 is used, and the characters are shifted to the right side, the characters may be corrected so as to be positioned at the center as shown in FIG. 7E.

In the example of FIG. 7F, an OSD image is displayed in 3D so as to be superimposed on a 3D input image. In such a case, since both the background input image and the OSD image are displayed in 3D, a user can perform an operation while reading the content of the OSD image without discomfort in a state of wearing polarized glasses, for example.

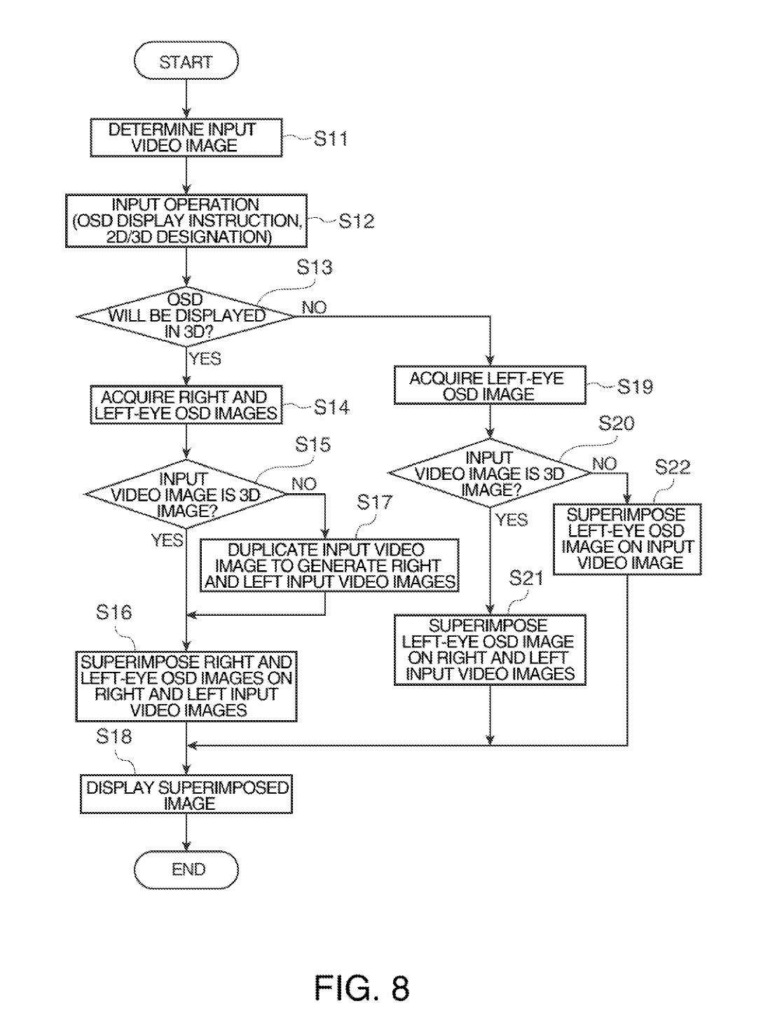

FIG. 8 is a flowchart showing the operation of the projector 1.

The display controller 15 of the projector 1 causes the image determiner 22 to determine whether an input image is a 3D video image or a 2D video image (step S11). When the input image is a 3D video image, the image determiner 22 also checks the image format (such as a line alternative format, a frame sequential format, or a side-by-side format), and determines whether the data being input is a data of left-eye frame or a data of right-eye frame. The determination result is output from the image determiner 22 to the image reader 23 and the image combiner 24.

Subsequently, the content of operations by the user relating to the display of the OSD image, input through the remote control 5 or the operation panel 51 is acquired and analyzed by the controller 11 (step S12). The controller 11 determines whether the OSD image will be displayed in 3D or 2D based on the content of the operations (step S13). When displaying the OSD image in 3D (step S13: Yes), the image reader 23 acquires both the left and right-eye OSD images 31 and 32 from the OSD image memory 3 (step S14).

Subsequently, the image combiner 24 determines whether the input video image is a 3D video image or not based on the result of the determination by the image determiner 22 (step S15). When the input video image is a 3D video image, the left and right-eye OSD images 31 and 32 are superimposed on the left and right-eye frames of the input video image, respectively (step S16). On the other hand, when the input video image is not a 3D video image (step S15: No), the image combiner 24 duplicates the frames of the input video image and uses one of the frames as the left-eye frame and the other frame as the right-eye frame (step S17) and performs the process of step S16. After that, the image combined by the image combiner 24 is input to the liquid crystal panel driver 17, and the liquid crystal panel driver 17 draws the image on the liquid crystal panel 42, and the image is projected onto the screen SC (step S18).

Moreover, when the OSD image is not displayed in 3D (step S13: No), the image reader 23 acquires only the left-eye OSD image 31 from the OSD image memory 3 (step S19). Subsequently, the image combiner 24 determines whether the input video image is a 3D video image or not based on the result of the determination by the image determiner 22 (step S20). When the input video image is a 3D video image, the left-eye OSD image 31 is superimposed on the left and right-eye frames of the input video image, respectively (step S21). On the other hand, when the input video image is not a 3D video image (step S20: No), the image combiner 24 superimposes the left-eye OSD image 31 on the input video image (step S22). After that, in step S18, the image combined by the image combiner 24 is input to the liquid crystal panel driver 17, and the liquid crystal panel driver 17 draws the image on the liquid crystal panel 42, and the image is projected onto the screen SC.

As described above, the projector 1 according to the embodiment to which the invention is applied includes the OSD image memory 3 that stores an OSD image to be superimposed on an input video image, the image reader 23 that acquires the left and right-eye OSD images 31 and 32 based on the OSD image stored in the OSD image memory 3, the image combiner 24 that acquires the left and right-eye frames from the input video image and superimposes the left and right-eye OSD images 31 and 32 acquired by the image reader 23 on the left and right-eye frames of the input video image to thereby generate a 3D display image, and the display unit 40 that displays the 3D display image generated by the image combiner 24. The projector 1 is capable of displaying the OSD image so as to be superimposed on an image including the left and right-eye frames. In this case, when the same image is used as the left and right-eye OSD images 31 and 32, only the OSD image can be displayed as a 2D image. When a pair of images with parallax is used as the left and right-eye OSD images 31 and 32, the OSD image can be displayed in 3D. In this way, it is possible to display the OSD image effectively by combining the 3D image and the OSD image.

The display controller 15 of the projector 1 further includes the image determiner 22 that determines the image format (such as a line alternative format, a frame sequential format, or a side-by-side format) of the input 3D image when a 3D image including a pair of left and right-eye frames is input as the input video image. In this case, the image combiner 24 superimposes the left and right-eye OSD images 31 and 32 acquired by the image reader 23 on the left and right-eye frames of the input video image in correspondence to the image format determined by the image determiner 22 to thereby generate the 3D display image. Thus, it is possible to display the left and right-eye OSD images 31 and 32 so as to be superimposed on the input 3D image appropriately in correspondence to the image format of the input 3D image.

Moreover, when a pair of left and right-eye frames is alternately input as the input video image, the image determiner 22 determines whether the frame of the image input alternately is a left-eye frame or a right-eye frame. The image combiner 24 superimposes the left-eye OSD image 31 on the left-eye frame determined by the image determiner 22 and superimposes the right-eye OSD image 32 on the right-eye frame determined by the image determiner 22 to thereby generate the 3D display image. Thus, it is possible to reliably discriminate the left and right-eye frames input alternately and to display the left and right-eye OSD images 31 and 32 so as to be superimposed on the input 3D image appropriately.

Moreover, when the input video image is a 2D image, the image combiner 24 duplicates the 2D image to generate two images of the same content to acquire one of the frames as the left-eye frame and the other frame as the right-eye frame. Thus, even when the input video image is a 2D image, it is possible to display the OSD image in 3D and to effectively display the OSD image.

Furthermore, the OSD image memory 3 stores the left and right-eye OSD images 31 and 32 in advance, and the image reader 23 reads and superimposes the left and right-eye OSD images 31 and 32 stored in advance. Thus, it is possible to quickly execute the process of superimposing the OSD image.

Moreover, the image combiner 24 determines whether the input video image is a 3D video image based on the result of the determination by the image determiner 22. When the input image is a 2D image, the left-eye OSD image 31 stored in the OSD image memory 3 is read and displayed so as to be superimposed on the input image. Thus, it is possible to display a 2D OSD image by using the left-eye OSD image 31 which is stored in advance in order to display the OSD image in 3D.

In the above embodiment, a configuration in which the left and right-eye OSD images 31 and 32 are stored in the OSD image memory 3, the left and right-eye OSD images 31 and 32 are used when displaying the OSD image in 3D, and only the left-eye OSD image 31 is displayed when displaying the OSD image in 2D has been described as an example. However, the invention is not limited to this, and a 2D OSD image may be stored in the OSD image memory 3 in addition to the left and right-eye OSD images 31 and 32. Moreover, a reference OSD image may be stored in the OSD image memory 3 in a format such that the positions of the background and the characters can be individually adjusted, the left and right-eye OSD images may be generated based on the reference OSD image and used when displaying the OSD image in 3D, and a 2D OSD image may be generated from the reference OSD image and displayed when displaying the OSD image in 2D. In this case, it is possible to display the OSD image in 3D with a small storage capacity.

Moreover, in the above embodiment, a configuration in which when the input video image is a 2D video image, and the OSD image is displayed in 2D, the left-eye OSD image 31 stored in the OSD image memory 3 is read (step S19 in FIG. 8) and displayed so as to be superimposed on the input video image (step S22) has been described as an example. However, the invention is not limited to this, and the right-eye OSD image 32 may be acquired from the OSD image memory 3 and displayed in a superimposed manner. In this case, the OSD image can be displayed in 2D using the image prepared in advance to display the OSD image in 3D.

The embodiment described above is just an example of a specific mode, to which the invention is applied, and does not restrict the invention, but the invention can be applied in other modes different from the embodiment. Moreover, in the above embodiment, a configuration in which the display unit 40 uses three transmissive or reflective liquid crystal panels 42 corresponding to the respective colors of RGB as a modulator that modulates light emitted from the light source has been described. However, the invention is not limited to this, and for example, the modulator may be a system which uses a liquid crystal panel and a color wheel, a system which uses three digital mirror devices (DMD), or a DMD system which uses a digital mirror device and a color wheel are combined. Here, when only one liquid crystal panel or a DMD is used as the modulator, a constituent member corresponding to a combination optical system such as a cross dichroic prism is not necessary. Moreover, besides the liquid crystal panel and the DMD, any configuration which is capable of modulating light emitted from the light source can be used. Moreover, in the above embodiment, a configuration in which the image combiner 24 performs the superimposition process depending on whether the format of the input video image determined by the image determiner 22 is the line alternative format, the frame sequential format, or the side-by-side format has been described as an example. However, the format of the input video image is not limited to the above example, and the image determiner 22 may determine the frame rate or the resolution of the input video image, and the image combiner 24 may perform other processes depending on the determination result.

Furthermore, in the above embodiment, a configuration in which the display controller 15 processes the input video image input from the external image supply device and superimposes and projects the OSD image on the input video image has been described. However, the invention is not limited to this, and an image supply device such as an external personal computer connected to the projector 1 may execute the process of superimposing the OSD. In this case, the image supply device may include the functions of the controller 11, the storage unit 12, and the display controller 15 of the projector 1. Moreover, the invention may be implemented as a program executed by such a device. In such a configuration, the projector 1 may project images input from the image supply device onto the screen SC.

Furthermore, the display device of the invention is not limited to the projector that projects video images onto the screen SC. The display device of the invention includes various display devices such as a liquid crystal monitor or a liquid crystal TV that displays images or videos on a liquid crystal display panel, a monitor device or a television receiver that displays images or videos on a plasma display panel (PDP), or a self-emission display device of a monitor device or a TV receiver that displays images or videos on an organic EL display panel commonly called an organic light-emitting diode (OLED), an organic electro-luminescence (OEL), or the like. In this case, the liquid crystal display panel, the plasma display panel, and the organic EL display panel correspond to the display unit.

Moreover, the respective functional units of the projector 1 shown in FIG. 1 show the functional configurations of the projector 1, and a specific implementation form is not particularly limited. That is, it is not always necessary to implement individual hardware corresponding to the respective functional units, and naturally, the functions of a plurality of functional units may be realized when a processor executes a program. For example, the whole display controller 15 that includes the display mode selector 21, the image determiner 22, the image reader 23, and the image combiner 24 may be configured as a single device, and the functions of the controller 11 and the display controller 15 may be realized by a single device. Furthermore, in the above embodiment, a part of the functions realized by software may be realized by hardware, and alternatively, a part of the functions realized by hardware may be realized by software. In addition, a specific detailed configuration of the projector 1 may be optionally changed without departing from the spirit of the invention.

What is claimed is:

1. A display device comprising:
an image acquisition unit that acquires a left-eye image and a right-eye image based on an input image;
a storage unit that stores an OSD image;
an OSD image acquisition unit that acquires at least one of a left-eye OSD image and a right-eye OSD image based on the OSD image stored in the storage unit;
an image combination unit that superimposes the OSD images acquired by the OSD image acquisition unit on the left and right-eye images acquired by the image acquisition unit to thereby generate an image; and
a display unit that displays the image generated by the image combination unit.

2. The display device according to claim 1, further comprising
a determining unit that determines an image format of the input image in case that the input image is a 3D image which includes a left-eye image and a right-eye image,
wherein the OSD image acquisition unit acquires the left-eye OSD image and the right-eye OSD image, and
wherein the image combination unit superimposes the left and right-eye OSD images acquired by the OSD image acquisition unit on the left and right-eye images included in the input image, respectively, based on the image format determined by the determining unit to thereby generate a 3D image.

3. The display device according to claim 2,
wherein the determining unit determines whether the input image or a part of the input image is a left-eye image or a right-eye image, and
wherein the image combination unit superimposes the left-eye OSD image on an image which is determined to be the left-eye image by the determining unit and superimposes the right-eye OSD image on an image which is determined to be the right-eye image by the determining unit to thereby generate the 3D image.

4. The display device according to claim 1,
wherein in case that the input image is a 2D image, the image acquisition unit duplicates the input image to acquire one of the images as a left-eye image and the other image as a right-eye image.

5. The display device according to claim 1,
wherein the OSD image acquisition unit reads the left and right-eye OSD images which are stored in advance in the storage unit.

6. The display device according to claim 1,
wherein in case that the input image is a 2D image, the OSD image acquisition unit reads any one of the left and right-eye OSD images which are stored in advance in the storage unit, and
wherein the image combination unit superimposes the image read by the OSD image acquisition unit on the input image to thereby generate an image.

7. The display device according to claim 1,
wherein the OSD image acquisition unit generates the left and right-eye OSD images based on the OSD image which is the 2D image stored in advance in the storage unit.

8. A method of controlling a display device, comprising the steps of;
acquiring at least one of a left-eye OSD image and a right-eye OSD image based on an OSD image which is stored in advance;
superimposing the acquired OSD images on the acquired left and right-eye images based on an input image to thereby generate an image; and
displaying the generated image.

9. A non-transitory computer readable storage medium storing a program with computer, comprising the functions as;
an image acquisition unit that acquires a left-eye image and a right-eye image based on an input image;
a storage unit that stores an OSD image;
an OSD image acquisition unit that acquires at least one of a left-eye OSD image and a right-eye OSD image based on the OSD image stored in the storage unit;
an image combination unit that superimposes the OSD images acquired by the OSD image acquisition unit on the left and right-eye images acquired by the image acquisition unit to thereby generate an image; and
a controller that causes a display unit to display the image generated by the image combination unit.
